(19) United States
(12) Patent Application Publication
(10) Pub. No.: US 2009/0190452 A1
(43) Pub. Date: Jul. 30, 2009

(54) Device and Method for Controlling Zero-Return of Opto-Mechanical System

(75) Inventor: Chun-Lung Ho, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/130,006

(22) Filed: May 30, 2008

(30) Foreign Application Priority Data
Jan. 24, 2008 (CN) 200810003874.7

(51) Int. Cl. G11B 7/085; G11B 17/028

(52) U.S. Cl. 369/47.36; 720/695

(57) ABSTRACT

A device for controlling zero-return of an opto-mechanical system of an optical disc drive is provided. The opto-mechanical system has an optical pickup head for reading data from an optical disc. The zero-return controlling device includes a servo system, a stepper motor driver chip and a signal detecting unit. The servo system issues a triggering signal when the optical disc is loaded. The stepper motor driver chip issues a stepper motor driving signal to the stepper motor in response to the triggering signal. The stepper motor is driven to rotate in response to the stepper motor driving signal. The signal detecting unit is used for detecting the magnitude of the stepper motor driving signal. A suspending signal is issued from the signal detecting unit to the stepper motor driver chip to stop the stepper motor if the magnitude of the stepper motor driving signal exceeds a threshold value.

### FIELD OF THE INVENTION

The present invention relates to a method and a device for controlling zero-return, and more particularly to a method and a device for controlling zero-return of an opto-mechanical system.

### BACKGROUND OF THE INVENTION

With increasing applications of personal computers and multimedia techniques, the data storage media with high data storage density are now rapidly gaining in popularity. Optical discs such as compact discs (CDs), video compact discs (VCDs) and digital versatile discs (DVDs) are widely employed to store considerable digital data due to features of low cost, high capacity and portability. Accordingly, optical disc drives become essential components for reading data from optical discs.

Generally, a tray-loading mechanism and a slot-loading mechanism are commonly used to load an optical disc into the optical disc drive. For loading an optical disc via a tray-loading mechanism, a tray is pulled out of the optical disc drive. After the optical disc is positioned in the tray, the tray is pushed back into the optical disc drive. For loading an optical disc via a slot-loading mechanism, the optical disc is drawn into a slot of the optical disc drive. After the optical disc is loaded into the optical disc drive by the tray-loading mechanism or the slot-loading mechanism, initiation of the optical disc drive is done. During the loading process, it is critical to drive the opto-mechanical system of the optical disc to return to zero, which will be described in the following paragraphs.

FIG. 1 schematically illustrates a conventional optical disc drive. FIG. 2 is a schematic top view illustrating the optical disc drive of FIG. 1. For clarification and brevity, some components are not shown in FIG. 2. The conventional optical disc drive principally comprises a spindle motor 1, an opto-mechanical system 3, a stepper motor 4, a gear set 5 and a rack 6. An optical disc 2 is fixed on the spindle motor 1 by a clamper and is driven to rotate by the spindle motor 1. The opto-mechanical system 3 has an optical pickup head 30 for reading data from the optical disc 2. The rack 6 is connected to one side of the opto-mechanical system 3. The opto-mechanical system 3 is supported on two guide rods 7A and 7B (as shown in FIG. 2). For reading/writing data on the rotating optical disc 2, the opto-mechanical system 3 is moved on the guide rods 7A and 7B in the radial direction of the optical disc 2 such that the optical pickup head 30 moves through the tracks of the optical disc 2. As shown in FIG. 2, the opto-mechanical system 3 can be moved between an innermost position 31 and an outermost position 32 so as to read/write the data on the optical disc 2 from the center to the edge of the optical disc 2. For confining the movable range of the opto-mechanical system 3, confining elements (not shown) are arranged at the innermost position 31 and the outermost position 32 to prevent the opto-mechanical system 3 from colliding with other components of the optical disc drive.

The gear set 5 is driven by the stepper motor 4. The gear set 5 is engaged with the rack 6. Upon rotation of the stepper motor 4, the gear set 5 drives the opto-mechanical system 3 to move. By controlling the rotating speed and direction of the stepper motor 4, the rotating speed and the direction of the opto-mechanical system 3 and thus the position of the opto-mechanical system 3 are adjustable. The operation principles of the opto-mechanical system 3 and the stepper motor 4 are known in the art, and are not redundantly described herein.

Please refer to FIGS. 1 and 2 again. During the loading process, the opto-mechanical system 3 of the optical disc drive will perform a zero-return operation. That is, regardless of where the opto-mechanical system 3 is located, the opto-mechanical system 3 should be returned to the innermost position 31 before reading/writing the optical disc 2. Since the information associated with the initial position of the opto-mechanical system 3 is not recorded by the optical disc drive, complicated algorithm and a position detector are employed to measure the initial position of the opto-mechanical system 3 to control the zero-return of the opto-mechanical system 3. According to the measured initial position of the opto-mechanical system 3, the shift amount for the opto-mechanical system 3 to move to zero is calculated. According to the calculated shift amount, the opto-mechanical system 3 is moved to the innermost position 31. As known, the complicated algorithm and the additional position detector increase the fabricating cost and the complexity of the optical disc drive.

In accordance with another zero-return controlling method of the opto-mechanical system 3 to return to zero, the opto-mechanical system 3 is driven to move for a predetermined maximum shift amount. The predetermined maximum shift amount denotes the distance between the innermost position 31 and the outermost position 32. In other words, regardless of where the opto-mechanical system 3 is located, the predetermined maximum shift amount is sufficient to return the opto-mechanical system 3 to zero. For example, even if the opto-mechanical system 3 is located at the outermost position 32, the opto-mechanical system 3 can be moved to the innermost position 31. Moreover, the optical disc drive has a sensing device (not shown) at the innermost position 31. The sensing device is, for example, a mechanical switch or an optical switch for indicating whether the opto-mechanical system 3 is moved to the innermost position 31. When the sensing device discriminates that the opto-mechanical system 3 is moved to the innermost position 31, the sensing device issues a suspending signal to the stepper motor 4. In response to the suspending signal, the stepper motor 4 stops rotating so as to stop moving the opto-mechanical system 3. As known, the use of the sensing device also increases the hardware components and the fabricating cost of the optical disc drive.

If the sensing device is absent or has a breakdown, the stepper motor 4 may continuously drive the opto-mechanical system 3 after the opto-mechanical system 3 has been moved to the innermost position 31. Under this circumstance, the opto-mechanical system 3 is readily suffered from an erroneous action. In addition, the opto-mechanical system 3 may collide with the confining elements, which may cause intermittent noise. Furthermore, a drag force resulted from collision is applied on the stepper motor 4. Under this circumstance, the temperature of a stepper motor driver chip for driving the stepper motor 4 is rapidly increased and thus the stepper motor driver chip may have a breakdown due to overheating.

As previously described, the uses of complicated algorithm to calculate the initial position of the opto-mechanical system and the additional position detector increase the fabricating cost and the complexity of the optical disc drive as well as using the sensing device for discriminating whether the opto-mechanical system reaches the innermost position 31.

Therefore, there is a need of providing improved zero-return controlling device and method to obviate the drawbacks encountered from the prior art.

### SUMMARY OF THE INVENTION

The present invention provides a zero-return controlling device for moving the opto-mechanical system to the innermost position. When the opto-mechanical system reaches the innermost position, the opto-mechanical system stops moving forwardly so as to prevent from causing intermittent noise, collision or breakdown.

In accordance with an aspect of the present invention, there is provided a device for controlling zero-return of an opto-mechanical system in an optical disc drive. The opto-mechanical system has an optical pickup head for reading data from an optical disc. The zero-return controlling device includes a servo system, a stepper motor driver chip and a signal detecting unit. The servo system issues a triggering signal when the optical disc is loaded. The stepper motor driver chip issues a stepper motor driving signal to the stepper motor in response to the triggering signal. The stepper motor is driven to rotate in response to the stepper motor driving signal. The signal detecting unit is used for detecting the magnitude of the stepper motor driving signal. A suspending signal is issued from the signal detecting unit to the stepper motor driver chip to stop the stepper motor if the magnitude of the stepper motor driving signal exceeds a threshold value.

In accordance with another aspect of the present invention, there is provided a zero-return controlling method for use in an optical disc drive. The optical disc drive includes an opto-mechanical system, a servo system, a stepper motor driver chip, a signal detecting unit and a stepper motor. The zero-return controlling method includes steps of: issuing a loading signal to the servo system when an optical disc is loaded; issuing a triggering signal from the servo system to the stepper motor driver chip in response to the loading signal; issuing a stepper motor driving signal from the stepper motor driver chip to the stepper motor in response to the triggering signal; driving the stepper motor to rotate in response to the stepper motor driving signal; detecting the magnitude of the stepper motor driving signal by the signal detecting unit; and issuing a suspending signal from the signal detecting unit to the stepper motor driver chip to stop the stepper motor if the magnitude of the stepper motor driving signal exceeds a threshold value.

### BRIEF DESCRIPTION OF THE DRAWINGS

The above contents of the present invention will become more readily apparent to those ordinarily skilled in the art after reviewing the following detailed description and accompanying drawings, in which:

FIG. 1 schematically illustrates a conventional optical disc drive;

FIG. 2 is a schematic top view illustrating the optical disc drive of FIG. 1;

FIG. 3 is a schematic diagram illustrating a zero-return controlling device for an optical disc drive according to a preferred embodiment of the present invention;

FIG. 4 is a flowchart of a zero-return controlling method according to the present invention; and

FIG. 5 is a schematic timing diagram illustrating the current signal varied with time.

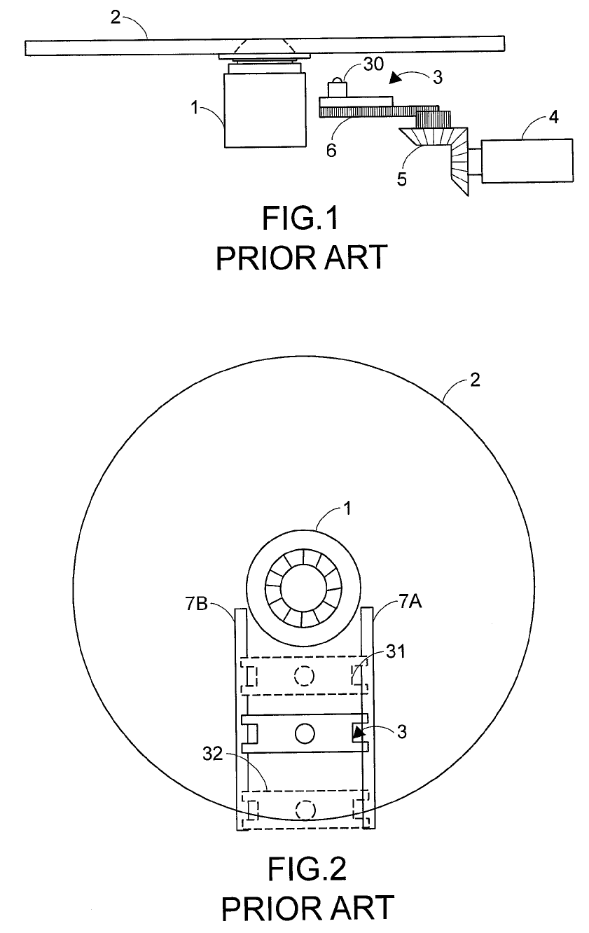

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

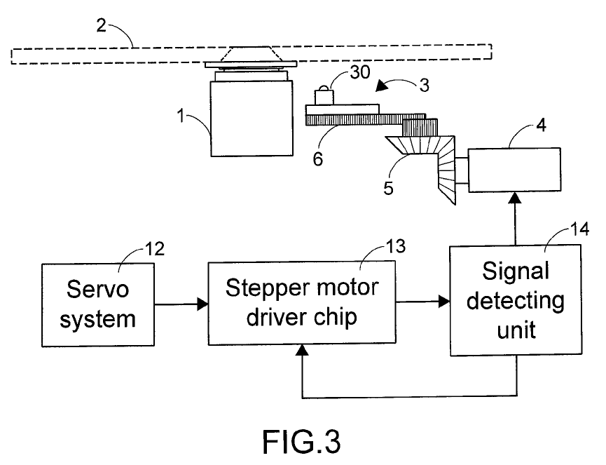

FIG. 3 is a schematic diagram illustrating a zero-return controlling device for an optical disc drive according to a preferred embodiment of the present invention. The optical disc drive of the present invention principally comprises a spindle motor 1, an opto-mechanical system 3, a stepper motor 4, a gear set 5, a rack 6 and a zero-return controlling device. The zero-return controlling device of the present invention principally comprises a servo system 12, a stepper motor driver chip 13, and a signal detecting unit 14.

When an optical disc is loaded into an optical disc drive by a tray-loading mechanism or a slot-loading mechanism, a loading signal is transmitted to the servo system 12. In response to the loading signal, the servo system 12 issues a triggering signal to the stepper motor driver chip 13. In response to the triggering signal, the stepper motor driver chip 13 issues a stepper motor driving signal to the stepper motor 4. In response to the stepper motor driving signal, the stepper motor 4 is driven to rotate. The stepper motor driving signal is, for example, a voltage signal or a current signal. Upon rotation of the stepper motor 4, the gear set 5 and the rack 6 are moved such that the opto-mechanical system 3 is moved along with the rack 6. The operation principles of the opto-mechanical system 3, the stepper motor 4, the gear set 5 and the rack 6 are known in the art, and are not redundantly described herein.

The signal detecting unit 14 is used for detecting the magnitude of the stepper motor driving signal. The signal detecting unit 14 may be integrated into the stepper motor driver chip 13. In a case that the stepper motor driving signal is a current signal, an exemplary signal detecting unit 14 includes, but is not limited to, a Hall current sensor or a current transformer (CT) for detecting the magnitude of the stepper motor driving signal. In response to the stepper motor driving signal transmitted from the stepper motor driver chip 13, the stepper motor 4 is driven to rotate such that the opto-mechanical system 3 is moved by the transmission linkage of the gear set 5 and the rack 6. When the opto-mechanical system 3 is moved to the innermost position 31 (as shown in FIG. 2), the opto-mechanical system 3 touches the confining element which is arranged at the innermost position 31. Meanwhile, a counterforce from the confining element is exerted on the opto-mechanical system 3 to stop the opto-mechanical system 3 moving forwardly. The counterforce increases a burden on the stepper motor 4 and thus a large transient current is outputted from the stepper motor 4. If the signal detecting unit 14 detects that the magnitude of the transient current exceeds a threshold value, the signal detecting unit 14 issues a suspending signal to the stepper motor driver chip 13. In response to the suspending signal, the stepper motor driver chip 13 stops driving the stepper motor 4. Therefore, the opto-mechanical system 3 will be precisely stayed at the innermost position 31.

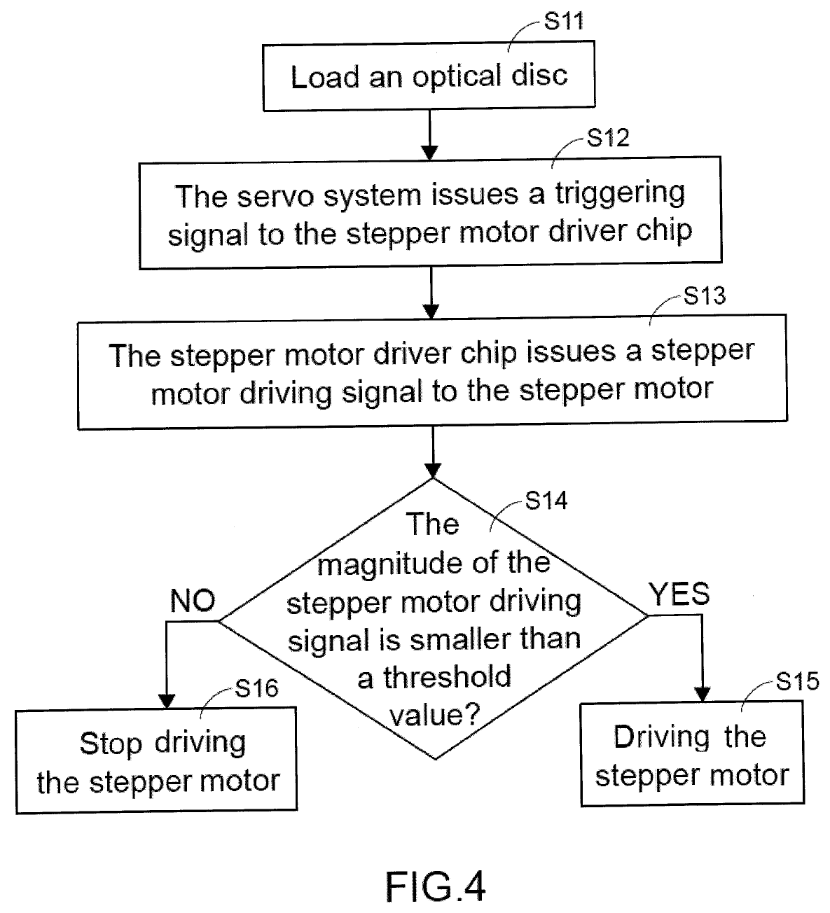

Hereinafter, a zero-return controlling method will be illustrated in more details with reference to a flowchart of FIG. 4 and the device of FIG. 3.

First of all, an optical disc is loaded into an optical disc drive by a tray-loading mechanism or a slot-loading mechanism and thus a loading signal is transmitted to the servo system 12 (Step S11). In response to the loading signal, the servo system 12 issues a triggering signal to the stepper motor driver chip 13 (Step S12). In response to the triggering signal, the stepper motor driver chip 13 issues a stepper motor driving signal to the stepper motor 4 (Step S13). In response to the stepper motor driving signal, the stepper motor 4 is driven to rotate. If the signal detecting unit 14 detects that the magnitude of the stepper motor driving signal is smaller than a threshold value (Step S14), the stepper motor 4 is continuously rotated until the opto-mechanical system 3 reaches the innermost position 31 (Step S15). Whereas, if the magnitude of the stepper motor driving signal exceeds the threshold value, the signal detecting unit 14 issues a suspending signal to the stepper motor driver chip 13. In response to the suspending signal, the stepper motor driver chip 13 stops driving the stepper motor 4 (Step S16).

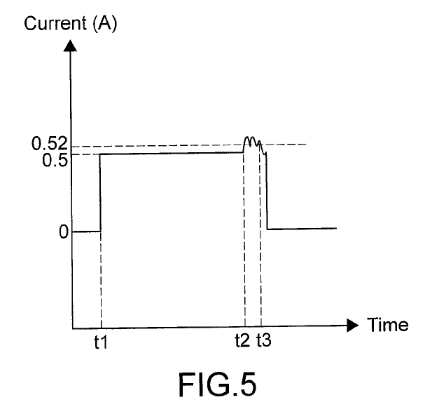

FIG. 5 is a schematic timing diagram illustrating the current signal varied with time. When an optical disc is loaded at time t1, the servo system 12 issues a triggering signal to the stepper motor driver chip 13. In response to the triggering signal, the stepper motor driver chip 13 issues a stepper motor driving signal of approximately 0.5 A to drive the stepper motor 4. Upon rotation of the stepper motor 4, the opto-mechanical system 3 is smoothly moved on the guide rods 7A and 7B because the burden on the stepper motor 4 is very small. Under this circumstance, the magnitude of the current signal detected by the signal detecting unit 14 is substantially kept unchanged. When the opto-mechanical system 3 is moved to the innermost position 31 at time t2, the opto-mechanical system 3 touches the confining element at the innermost position 31 and thus a counterforce from the confining element is exerted on the opto-mechanical system 3. Since the counterforce increases the burden on the stepper motor 4, an increased transient current is outputted from the stepper motor 4. If the magnitude of the transient current detected by the signal detecting unit 14 is over the threshold value (e.g. 0.52 A) for a certain time interval, the signal detecting unit 14 issues a suspending signal to the stepper motor driver chip 13 at time t3. In response to the suspending signal, the stepper motor driver chip 13 stops driving the stepper motor 4. Therefore, the opto-mechanical system 3 will be precisely stayed at the innermost position 31.

From the above description, the zero-return controlling device and the zero-return controlling method of the present invention can control the opto-mechanical system to return to zero by detecting the stepper motor driving signal. Since neither complicated algorithm nor no position detector is employed to measure the initial position of the opto-mechanical system 3, the fabricating cost and the complexity of the optical disc drive are reduced. In addition, the zero-return controlling device is cost-effective because no sensing device arranged at the innermost position is required. Moreover, by the zero-return controlling device and the zero-return controlling method of the present invention, the opto-mechanical system can be precisely stayed at the innermost position. As a consequence, the possibility of causing intermittent noise, erroneous action of the opto-mechanical system and rapid temperature increase of the stepper motor driver chip will be minimized or eliminated.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for controlling zero-return of an opto-mechanical system in an optical disc drive, the opto-mechanical system having an optical pickup head for reading data from an optical disc, the zero-return controlling device comprising:
a servo system issuing a triggering signal when the optical disc is loaded;
a stepper motor driver chip issuing a stepper motor driving signal to the stepper motor in response to the triggering signal, wherein the stepper motor is driven to rotate in response to the stepper motor driving signal; and
a signal detecting unit for detecting the magnitude of the stepper motor driving signal, wherein a suspending signal is issued from the signal detecting unit to the stepper motor driver chip to stop the stepper motor if the magnitude of the stepper motor driving signal exceeds a threshold value.

2. The zero-return controlling device according to claim 1 wherein the opto-mechanical system is movable in a range between an innermost position and an outermost position.

3. The zero-return controlling device according to claim 1 wherein the stepper motor driving signal is a voltage signal.

4. The zero-return controlling device according to claim 1 wherein the stepper motor driving signal is a current signal.

5. The zero-return controlling device according to claim 4 wherein the signal detecting unit is a Hall current sensor or a current transformer.

6. A zero-return controlling method for an optical disc drive, the optical disc drive comprising an opto-mechanical system, a servo system, a stepper motor driver chip, a signal detecting unit and a stepper motor, the zero-return controlling method comprising steps of:
issuing a loading signal to the servo system when an optical disc is loaded;
issuing a triggering signal from the servo system to the stepper motor driver chip in response to the loading signal;
issuing a stepper motor driving signal from the stepper motor driver chip to the stepper motor in response to the triggering signal;
driving the stepper motor to rotate in response to the stepper motor driving signal;
detecting the magnitude of the stepper motor driving signal by the signal detecting unit; and
issuing a suspending signal from the signal detecting unit to the stepper motor driver chip to stop the stepper motor if the magnitude of the stepper motor driving signal exceeds a threshold value.

7. The zero-return controlling method according to claim 6 wherein the opto-mechanical system is movable in a range between an innermost position and an outermost position.

8. The zero-return controlling method according to claim 6 wherein the stepper motor driving signal is a voltage signal.

9. The zero-return controlling method according to claim 6 wherein the stepper motor driving signal is a current signal.

10. The zero-return controlling method according to claim 9 wherein the signal detecting unit is a Hall current sensor or a current transformer.
